(19) United States
(12) Patent Application Publication
(10) Pub. No.: US 2016/0229099 A1
(43) Pub. Date: Aug. 11, 2016

(54) MOLD FOR OVERMOLDING A COMPOSITE INSERT AND CORRESPONDING OVERMOLDING METHOD

(71) Applicant: Valeo Systemes Thermiques, Le Mesnil Saint Denis (FR)

(72) Inventors: Issmail Meskin, Le Mesnil-Saint-Denis (FR); Sebastien Velasco, Guyancourt (FR); Stephan Andre, Les Clayes-Sous-Bois (FR)

(73) Assignee: Valeo Systemes Thermiques, Le Mesnil Saint Denis (FR)

(21) Appl. No.: 15/026,642

(22) PCT Filed: Oct. 2, 2014
(86) PCT No.: PCT/EP2014/071173

§ 371 Date: Apr. 1, 2016

(30) Foreign Application Priority Data
Oct. 3, 2013 (FR) 1359577

(51) Int. Cl. B29C 45/40; B29C 43/50

(52) U.S. Cl. CPC B29C 45/40; B29C 43/50; B29K 2101/12

(57) ABSTRACT

The present invention relates to a mold (1) for the hot overmolding of a composite insert (5). Said mold comprises two complementary mold halves (3A, 3B) forming at least one overmolding cavity (7), inside of which the composite insert (5) is intended to be extended. The overmolding cavity (7) comprises at least one ejector (9) arranged in the wall of one of the mold halves (3A, 3B). Said at least one ejector (9) is movable between a retracted position and a deployed position, where said at least one ejector (9) holds the composite insert (5) against the opposite wall of said overmolding cavity (7).

The present invention concerns a mold for overmolding a composite insert and the associated overmolding method, more particularly in the field of the manufacture of composite motor vehicle components.

In the automotive field, motor vehicle manufacturers are increasingly seeking components that combine strength with the lowest possible weight. Thus for the manufacture of strong components it is known to replace components originally made of metal with plastic components including overmolded metal inserts. In order to obtain even lighter components whilst preserving a mechanical strength corresponding to the requirements of the manufacturers, the metal inserts may be replaced by composite, for example fiberglass, inserts.

Overmolding composite inserts is known in the art and is generally carried out at raised temperature and because of this the hot and deformable ends of the composite insert may become creased during the injection of the thermoplastic material, which can lead to weakening of the finished component.

One of the objects of the invention is therefore to remedy at least some of the disadvantages of the prior art and to propose a mold for hot overmolding and an improved hot overmolding method.

The present invention therefore concerns a mold for the hot overmolding of a composite insert, said mold including two complementary mold halves forming at least one overmolding cavity inside which the composite insert is intended to be extended, the overmolding cavity including at least one ejector arranged in the wall of one of the mold halves, said at least one ejector being movable between a retracted position and a deployed position in which said at least one ejector presses the composite insert against the opposite wall of said overmolding cavity.

Pressing the composite insert against a wall of the overmolding cavity prevents the formation of creases during the injection of hot thermoplastic material into the overmolding cavity by means of injectors. The injection pressure of the thermoplastic material therefore has little influence on the composite insert because the latter is held pressed against a wall of the overmolding cavity by at least one ejector.

In accordance with one aspect of the invention, the at least one ejector includes a perforating head intended to punch the composite insert and a retaining rim.

In accordance with another aspect of the invention, the overmolding cavity includes a plurality of ejectors.

In accordance with another aspect of the invention, the ejectors are all arranged on the same mold half.

In accordance with another aspect of the invention, the ejectors are situated on both mold halves.

In accordance with another aspect of the invention, said mold is also a hot compression mold.

The present invention also concerns a method of hot overmolding a composite insert in a mold, said mold including two complementary mold halves forming at least one overmolding cavity inside which the composite insert is intended to be extended, the overmolding cavity including at least one ejector arranged in the wall of one of the mold halves, said at least one ejector being movable between a retracted position and a deployed position,

said method including the following steps:
placing the composite insert between the two mold halves,
closing the overmolding mold,
deploying the at least one ejector into the overmolding cavity so as to press the composite insert against the wall of the overmolding cavity opposite said ejector,
injecting thermoplastic material into the overmolding cavity.

Because of the presence of at least one ejector in the overmolding cavity, the risk of the composite insert becoming creased is reduced by holding it against a wall of the overmolding cavity by means of the at least one ejector during the step of injection of the thermoplastic material.

In accordance with one aspect of the method in accordance with the invention the at least one ejector includes a perforating head and a retaining rim and during the step of deployment of said at least one ejector into the overmolding cavity the latter punches the composite insert.

In accordance with one aspect of the method in accordance with the invention while the mold is closed the composite insert is also hot compressed into a shape defined by the two mold halves.

Other features and advantages of the invention will become more clearly apparent on reading the following description given by way of illustrative and nonlimiting example, in which:

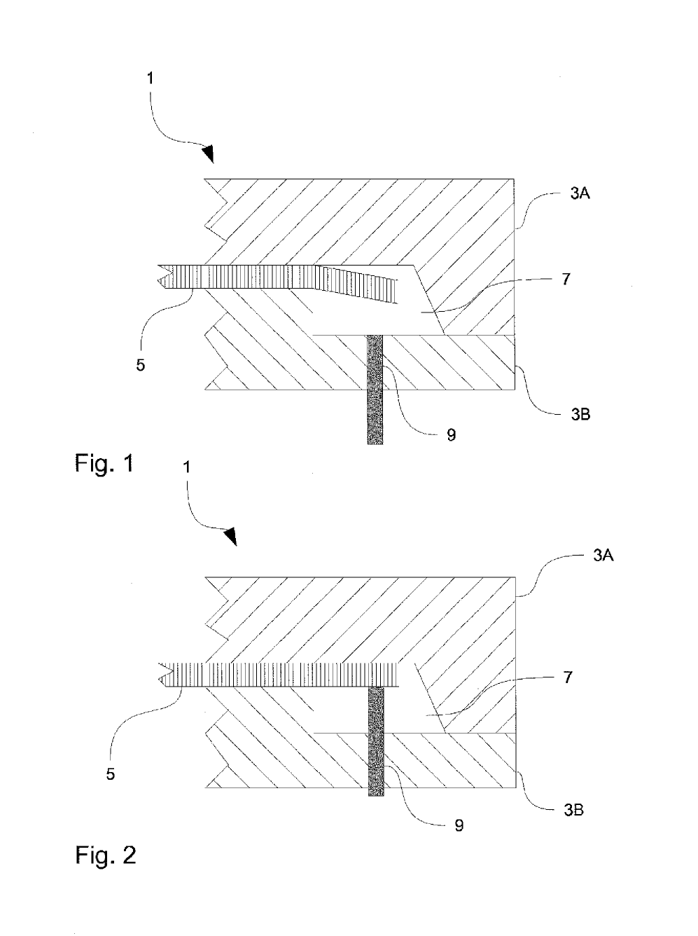

FIG. 1 shows a diagrammatic representation in section of a portion of a hot overmolding mold during a step of the overmolding process,

FIG. 2 shows a diagrammatic representation in section of a portion of a hot overmolding mold during a second step of the overmolding process,

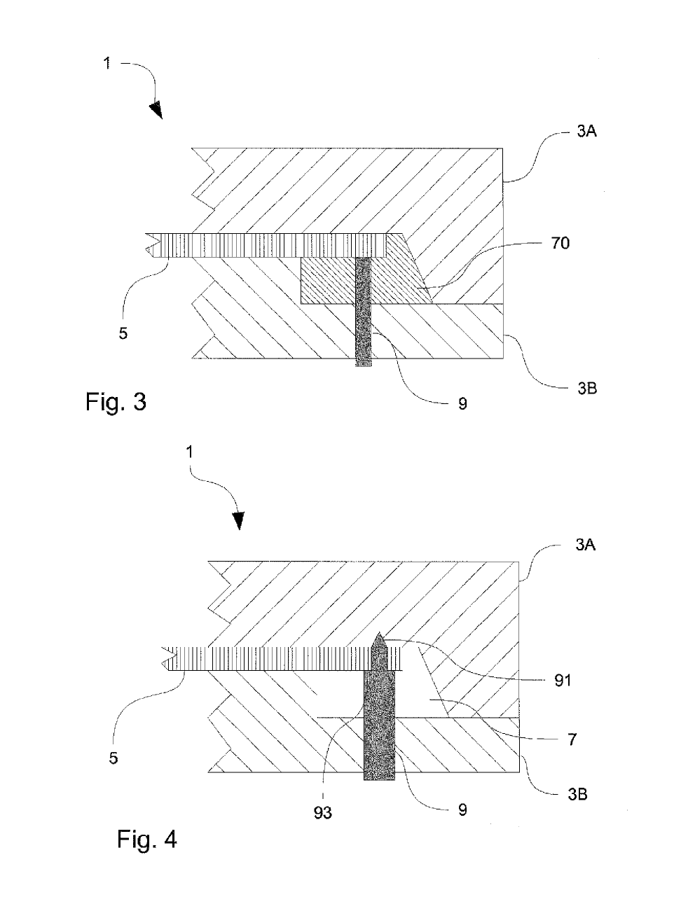

FIG. 3 shows a diagrammatic representation in section of a portion of a hot overmolding mold during a third step of the overmolding process,

FIG. 4 shows a diagrammatic representation in section of a portion of a variant hot overmolding mold during a step of the overmolding process.

Identical elements carry similar references in the various figures.

As FIGS. 1 to 4 show, the overmolding mold 1 includes two complementary mold halves 3A and 3B. The overmolding mold 1 also includes at least one overmolding cavity 7 recessed into the mold halves 3A, 3B. The overmolding mold 1 further includes at least one ejector 9 extending into the overmolding cavity 7 and movable between a retracted position and a deployed position.

A composite insert 5 is placed between the two mold halves 3A, 3B, for example an insert including fibers and a binding resin, such as a glass fiber insert, one of the ends of which is extended into the at least one overmolding cavity 7 when the overmolding mold 1 is closed.

The overmolding cavity 7 also includes at least one ejector 9 arranged in the wall of one of the mold halves 3A, 3B. Said at least one ejector 9 is movable between a retracted position (seen in FIG. 1) and a deployed position (seen in FIG. 2) in which said at least one ejector 9 presses the composite insert 5 onto the opposite wall of said overmolding cavity 7.

Pressing the composite insert 5 against a wall of the overmolding cavity 7 prevents the formation of creases during the injection of hot thermoplastic material 70 (seen in FIG. 3) into the overmolding cavity 7 by means of injectors (not shown). The injection pressure of the thermoplastic material 70 therefore has little influence on the composite insert 5 because the latter is held pressed against a wall of the overmolding cavity 7 by at least one ejector 9.

As FIG. 4 shows, the ejector 9 may include a perforating head 91 able to cut or to pass through the composite insert 5 and a retaining rim 93 in order to press said composite insert 5 against the wall of the overmolding cavity 7.

Without departing from the scope of the invention, the overmolding cavity 7 may include a plurality of ejectors 9. In accordance with a first variant, the ejectors 9 are arranged on the same mold half 3A or 3B.

In accordance with a second variant, the ejectors 9 are situated on both the mold halves 3A, 3B. In accordance with this second variant, it is therefore possible to have ejectors 9 on a first mold half 3A that press the composite insert 5 onto the wall of the overmolding cavity 7 of a second mold half 3B and ejectors 9 on the second mold half 3B that press the composite insert 5 onto the wall of the overmolding cavity 7 of the first mold half 3A. With this second variant, it is possible to interleave the composite insert 5 and the overmolded thermoplastic material 70, which improves the strength of the component.

In accordance with one particular embodiment, the overmolding mold 1 may also be a hot compression mold. Thus, when the mold 1 is closed, by virtue of their complementary shape, the two mold halves 3A and 3B can shape the composite insert 5 in accordance with a particular profile. A single mold 1 can therefore provide both the function of shaping the composite insert 5 and the function of overmolding said composite insert 5.

The present invention also concerns a method of hot overmolding a composite insert 5 in the mold 1 as described above.

The method of hot overmolding the composite insert 5 in the mold 1 includes the following steps:
a step of placing the composite insert 5 between the two mold halves 3A, 3B,
a step of closing the overmolding mold 1,
a step of deploying the at least one ejector 9 into the overmolding cavity 7 so as to press the composite insert 5 against the wall of the overmolding cavity 7 opposite said ejector 9,
a step of injecting thermoplastic material 70 into the overmolding cavity 7.

By virtue of the presence of at least one ejector 9 in the overmolding cavity, this overmolding method makes it possible to reduce the risks of the composite insert 5 becoming creased by holding it against a wall of the overmolding cavity 7 by means of the at least one ejector 9 during the step of injecting the thermoplastic material 70.

The step of deploying the at least one ejector 9 into the overmolding cavity 7 may also be a step in which said at least one ejector 9 punches the composite insert 5. To this end, the at least one ejector 9 includes a perforating head 91 that can cut or pass through the composite insert 5 and a retaining rim 93 to press said composite insert 5 against the wall of the overmolding cavity 7.

During the step of closing the overmolding mold 1, the composite insert 5 may also undergo hot compression in order to deform it and to impart to it a shape defined by the conformation of the two mold halves 3A, 3B.

It is therefore clear that by virtue of the presence of at least one ejector 9 in the overmolding cavity 7 of the overmolding mold 1 the risks of the composite insert 5 becoming creased during overmolding are greatly reduced.

1. A mold for the hot overmolding of a composite insert, said mold comprising:
two complementary mold halves forming at least one overmolding cavity inside which the composite insert extends,
wherein the overmolding cavity includes at least one ejector arranged in the wall of one of the mold halves, said at least one ejector being movable between a retracted position and a deployed position in which said at least one ejector presses the composite insert against the opposite wall of said overmolding cavity.

2. The mold as claimed claim 1, wherein the at least one ejector includes a perforating head intended to punch the composite insert and a retaining rim.

3. The mold as claimed in claim 1, wherein the overmolding cavity includes a plurality of ejectors.

4. The mold as claimed in claim 3, wherein the plurality of ejectors are all arranged on the same mold half.

5. The mold as claimed in claim 3, wherein the plurality of ejectors are situated on both mold halves.

6. The mold as claimed in claim 1, wherein said mold is also a hot compression mold.

7. A method of hot overmolding a composite insert in a mold having two complementary mold halves forming at least one overmolding cavity inside which the composite insert extends, the overmolding cavity including at least one ejector arranged in the wall of one of the mold halves, said at least one ejector being movable between a retracted position and a deployed position, the method comprising:
placing the composite insert between the two mold halves;
closing the overmolding mold;
deploying the at least one ejector into the overmolding cavity to press the composite insert against the wall of the overmolding cavity opposite said ejector; and
injecting thermoplastic material into the overmolding cavity.

8. The method as claimed in claim 7, wherein the at least one ejector includes a perforating head and a retaining rim and wherein, during the step of deployment of said at least one ejector into the overmolding cavity, the latter punches the composite insert.

9. The method as claimed in claim 7, further comprising: while the mold is closed, hot compressing the composite insert into a shape defined by the two mold halves.
